(19) United States
(12) Patent Application Publication
(10) Pub. No.: US 2016/0039138 A1
(43) Pub. Date: Feb. 11, 2016

(54) METHOD OF MANUFACTURING A STRAINABLE THERMOPLASTIC FILM MATERIAL, PRODUCT RESULTING THEREFROM, AND APPARATUS TO CARRY OUT THE METHOD

(71) Applicant: Ole-Bendt RASMUSSEN, Walchwil (CH)

(72) Inventor: Ole-Bendt Rasmussen, Walchwil (CH)

(21) Appl. No.: 14/776,495

(22) PCT Filed: Mar. 17, 2014
(86) PCT No.: PCT/EP2014/055345

§ 371 Date: Sep. 14, 2015

Related U.S. Application Data
(60) Provisional application No. 61/787,631, filed on Mar. 15, 2013.

(51) Int. Cl. B29C 47/00; B32B 38/00; B32B 27/08; B32B 27/32; B29C 47/88; B29C 39/00; B29C 39/14; B29C 39/38; B29C 55/06; B29C 47/06; B32B 37/20; B32B 3/10

(52) U.S. Cl. CPC B29C 47/0057; B32B 37/203; B32B 38/0012; B32B 38/0036; B32B 27/08; B32B 27/32; B32B 3/10; B29C 39/003; B29C 47/0004; B29C 39/148; B29C 39/38; B29C 55/06; B29C 47/0021; B29C 47/0064; B29C 47/065; B29C 47/8805; B29K 2023/12

(57) ABSTRACT

A pattern of embossment is made by a method producing short linear, mutually parallel bosses not directly formed by indentation, but formed by first making continuous, mutually parallel fine pleats or waves, and then interrupting this configuration at intervals by localized shrinkage.

### RELATED APPLICATIONS

This is a 35 U.S.C. §371 National Phase Application of PCT Application PCT/EP2014/055345 filed Mar. 17, 2014,

published as WO2014140380 A1 on Sep. 18, 2014, which claims priority to and the benefit of U.S. Provisional Patent Application Ser. No. 61/787,631, filed Mar. 15, 2013 (15 Mar. 2013).

### BACKGROUND OF THE INVENTION

1. Field of the Invention

The present invention relates to methods of manufacturing thermoplastic film exhibiting rubber like strain in one direction.

More particularly, the present invention relates to methods wherein an extruded or cast film is stretched to orient the film and render it shrinkable in one direction, pleating the film perpendicular to the direction in which it is shrinkable and heating areas of the film while allowing shrinking in the direction of shrinkability and preventing shrinking in the perpendicular direction so as to provide flattened areas while retaining pleated areas.

2. Description of the Related Art

While many applications of thermoplastic film material require high E-values and high yield tensions in all directions, several other applications require low E-values and a low yield tension at least in one direction, since this enhances tear propagation strength, tensile energy absorption, and resistance to penetration of relatively sharp items.

Examples of such applications are garbage bags, since such bags often become stuffed with coat hangers etc., and cling-film for wrapping of sharp-edged pallets or other sharp-edged items. In most of these cases, the film material is based on the use of relatively cheap polymers such as LDPE, LLDPE, HDPE, PP or blends thereof, and the film is not economically feasible to admix with a rubber component.

In the prior art, this problem has been solved by supplying the film with an embossment, which makes the film strainable in one direction, and which, therefore, gives the film an “apparent E-value” in this direction, which is lower than the real E-value, e.g., by a factor of 2 to 5, and which similarly reduces the yield tension. This has been described and claimed in U.S. Pat. Nos. 5,205,650 (Rasmussen); 5,518,803 (Chappell et al); 5,650,214 (Anderson et al); 5,691,035 (Chappell et al); and 5,723,087 (Chappell et al), which are incorporated by reference via the operation of the closing paragraph of this application.

In each of these patents, the “strainable embossment” consists of a pattern of short linear, mutually parallel bosses, produced by indentation. The simplest pattern is first disclosed in the Rasmussen patent, and is clearest illustrated on the front page of U.S. Pat. No. 5,691,035. The apparatus to make the indented pattern is clearest shown in the last mentioned U.S. Pat. No. 5,723,087, FIG. 36. It consists of mutually intermeshing grooved rollers with circular grooves, where the crests have deep indentations to form teeth, which are elongated in the direction perpendicular to the roller axis.

The achievement of “rubberlike” behavior, or in other words an “apparent E-value”, which is lower than the real E-value, e.g., demonstrated by the strain/stress graphs in the Rasmussen patent, FIGS. 4A 1-4 and 4B 1-4, and is explained in the description of these figures.

While the pattern of indentation shown in the Rasmussen patent is particularly simple, the other above mentioned prior art patents show more complicated and in some respect more advantageous patterns, all comprising short linear, mutually generally parallel bosses, produced by indentation.

In most cases, it would be advantageous to make the indentations as fine as practically possible, at the same time a relatively high depth may be advantageous.

The direction perpendicular to the extension of the short linear bosses is generally the direction in which the film has become most rubberlike. This can be chosen to be the machine direction of the film, or a direction perpendicular to the machine direction. In a bag, which is made yieldable, e.g., a trash bag, this yield should preferably take place in the transverse direction of the bag, to make the bag withstand the weight of the contents, when the bag is carried. Bags are often constructed in a way which makes the machine direction of the film the transverse direction of the bag. In such cases, it would be preferable to make the bosses extend perpendicular to the machine direction of the film.

In several of the above mentioned patents, this is achieved by means of mutually intermeshing gear rollers, in which each tooth extends axially and is indented, see e.g., U.S. Pat. No. 5,691,035, FIG. 37. However, with such gear rollers, it is very limited how fine the pitch can be made at the same time requiring depth of indentation be achieved. Improvement in this respect is one of the objectives of the present invention.

This problem does not exist to the same extent, when the direction chosen to be most rubberlike is perpendicular to the machine direction, so that the indentations can be made with circular grooved rollers. In this case, the mutually intermeshing of the grooved rollers can be made sufficiently deep for most purposes, even when the pitch of the grooving is as low as 1 mm. However, these grooved rollers of a low pitch and supplied with indentations are particularly expensive and are susceptible to damage, e.g., due to folds in the film.

Thus, there is a need in the art for new and novel methods and apparatuses for producing films having embossment patterns that improve film properties for use in bag applications and other application that require enhanced tear propagation strength, tensile energy absorption, and resistance to penetration of relatively sharp items.

### SUMMARY OF THE INVENTION

Embodiments of this invention provides methods of manufacturing a thermoplastic film, which exhibits rubberlike strain properties mainly in one direction (1). The methods include the step of extruding or casting a film. After extrusion or casting, the film is oriented all over within the entire film or within an area of the entire film by stretching having a component in the direction (1) to make the film shrinkable in the direction (1) below its melting range and simultaneously or subsequently giving the film or film area pleated or waved shapes with an average pitch of pleating or an average wavelength 5 mm or less, whereby the extension of the pleats or waves is perpendicular to direction (1). The methods also include heating the film or film area in a pattern consisting of regions (A) and allowing the film or film area to shrink in this pattern along direction (1), while a shrinkage perpendicular to direction (1) is prevented by holding means if a tendency to such shrinkage exists, whereby regions (A) become flattened, and unheated film regions (B) of the film or film area remain pleated or waved, with discontinuously extending pleats or waves.

In certain embodiments, the heating is carried out by a heated roller having protruding surface portions corresponding to the regions (A). In other embodiments, the average pitch of pleating or wavelength is at the highest 3 mm, while in other embodiments, the average pitch of pleating or wavelength is at the highest 2 mm and more preferably at the highest 1 mm. In other embodiments, the pleats or waves are brought to extend in the machine direction of the film, and the pleating or wave formation and at least a final step of the stretching is carried out by means of mutually intermeshing grooved rollers having circular grooves or helical grooves of a gradient lower than 45°. In other embodiments, the pleats or waves are brought to extend transverse of the machine direction of the film, and the pleating or wave formation and at least a final step of the stretching are carried out by mutually intermeshing grooved rollers having axial grooves or helical grooves of a gradient higher than 45°. The method according to claim 1, in which the pleats or waves are brought to extend transverse of the machine direction of the film, and the pleating or wave formation is carried out by stuffing the film or film area. In other embodiments, the stuffing is carried out between rubber belts which engage the film while they contract from a longitudinally strained state to a less strained state. In other embodiments, the friction between the film and the rubber belts has been enhanced by making the extruded or cast film a cling film by a suitable addition e.g. of polyisobutylene. In other embodiments, each of the regions (A) and (B) are made as bands which are rectilinearly extending either in the machine direction or in the transverse direction of the film.

The invention is defined in that method according to claim 1, in which each of the regions (A) are made as bands which extend in zig-zagging or waved manner. In other embodiments, each region (B) is being formed as a dot, which on all sides are surrounded by regions (A). In other embodiments, the film mainly consists of PP or HDPE or blends of the two, which one or two coextruded surface layers mainly consisting of LLDPE. In other embodiments, the film is made as a laminate of two or more individual films, whereby the lamination takes place after the extrusion or casting but before the step of producing pleating or waving. In other embodiments, the individual films are differently oriented to produce a crosslaminate. In other embodiments, the film is further processed to form a bag, e.g., a trash bag. In other embodiments, the film is further processed into a product for protection of sharp-edged items, e.g. of furniture.

Embodiments of this invention provide uses of the films manufactured according to the methods set forth above as a constituent in a product to cover the human body, e.g., in a diaper or raincoat.

Embodiments of this invention provide uses of the films manufactured according to methods set forth above in the hood or strapping or both of a parachute.

The invention also encompasses film manufactured by the methods set forth in the claims, and apparatus suitable for carrying out the methods set forth in the claims.

### BRIEF DESCRIPTION OF THE DRAWINGS

The invention can be better understood with reference to the following detailed description together with the appended illustrative drawings in which like elements are numbered the same:

FIG. 1 depicts a flow-sheet showing a procedure to make a film which is most strainable in the machine direction,

FIG. 2 depicts a flow-sheet showing a procedure to make a film which is most strainable transverse of the machine direction,

FIG. 3 to FIG. 6 depict are sketches showing different patterns of the pleated/waved regions (B), and the regions (A), which have been subjected to shrinkage and are flattened.

FIG. 7 is an enlarged photo, taken in perspective and in oblique light, of the film product produced as described in the sample. The mm scale refer to the front of the photo.

### DETAILED DESCRIPTION OF THE INVENTION

The inventor found that generally similar patterns of embossment are made by different methods, which solves the abovementioned problems and can supply a product of improved properties. In the methods, the short linear, mutually parallel bosses are not directly formed by indentation, but are formed by first making continuous, mutually parallel fine pleats or waves, and then interrupting this configuration at intervals by localized shrinkage. These methods are more precisely set forth in the Summary of the Invention.

The inventor was found that a film which first has been stretched and then subjected to shrinkage at an elevated temperature, but below its melting range, has retained a memory of its orientation state. The yield tension found, when it is brought back from its relaxed state into the same oriented state, is lower than the original yield tension, and the yield takes place more gradual. This is an advantage, e.g., for tear and puncture properties.

The present invention also has the objectives to fully or partly overcome the above mentioned practical difficulties found in the prior art. Especially, the invention is advantageous, when making the machine direction of the film strainable. In that case, the interrupted fine pleats or waves in regions (B) extend perpendicular to the machine direction. This can conveniently be achieved by stuffing, as further explained below, and hereby the pleating or waving can be finer and at the same time deeper than achieved by the known prior art methods.

When making the transverse direction of the film strainable, the interrupted fine pleats or waves in regions (B) must extend in the machine direction. In certain embodiments, the pleats or waves are formed by intermeshing grooved rollers with circular grooves. In that case, the crests of the grooved rollers are not indented, therefore cheaper, less susceptible to damage, and easier to repair, if the crests have become bended, compared to the prior art.

According to certain embodiments of the present invention, the heating needed for contraction of regions (A) is carried out by a heated roller, which has protruding surface portions corresponding to the regions (A). In other embodiments, there is installed a corresponding rubber coated nip-roller. In other embodiments, this rubber coated nip-roller should make exactly one revolution for each revolution of the heated roller, so that the rubber roller coat always becomes heated in the same regions.

For the sake of completeness, it should be mentioned that the heating of the regions (A) also can be carried out in a discontinuous manner in a press, in analogy with the discontinuous indentation shown in U.S. Pat. No. 5,691,035 Chappell et al, FIG. 35.

In certain embodiments, an average pitch of the pleating or wavelength is at the highest 2 mm, and still other embodiments, more the average pitch of the pleating or wavelength is at the highest 1 mm.

When the intent is to make the interrupted pleats or waves extend in the machine direction of the film, i.e., to make the transverse direction most strainable, the formation of pleats or waves prior to shrinkage, is preferably carried out by means of mutually intermeshing grooved rollers, which have circular grooves or helical grooves of a gradient lower than 45°.

If, on the contrary, the intent is to make the interrupted pleats or waves extend transverse of the machine direction of the film, i.e., to make the machine direction most shrinkable, the formation of pleats or waves prior to shrinkage and at least a final step of stretching, may be carried out by mutually intermeshing grooved rollers or rollers having axial grooves or helical grooves of a gradient higher than 45°. However, as it has been mentioned in the introduction, here it will normally be more advantageous to carry out the pleating by stuffing of the film.

Such stuffing can be carried out between rubber belts, which engage the film, while they contract from a longitudinally strained state. In this connection, reference is made to WO2002/051617 (Rasmussen).

In this connection, the friction between the rubber belts and the film is important in order to make the pleating or waving fine. Thus, in certain embodiments, the contacting surfaces of the rubber belts are preferably sand-blasted or better supplied with a fine transverse pattern of shallow grooves. Furthermore, the friction between the film and the belts may be enhanced by making the extruded or cast film a cling-film by a suitable addition, e.g., the addition of polyisobutylene. However, when the film is produced for bag making, only the surface that becomes the outer surface of the bag should contain such addition.

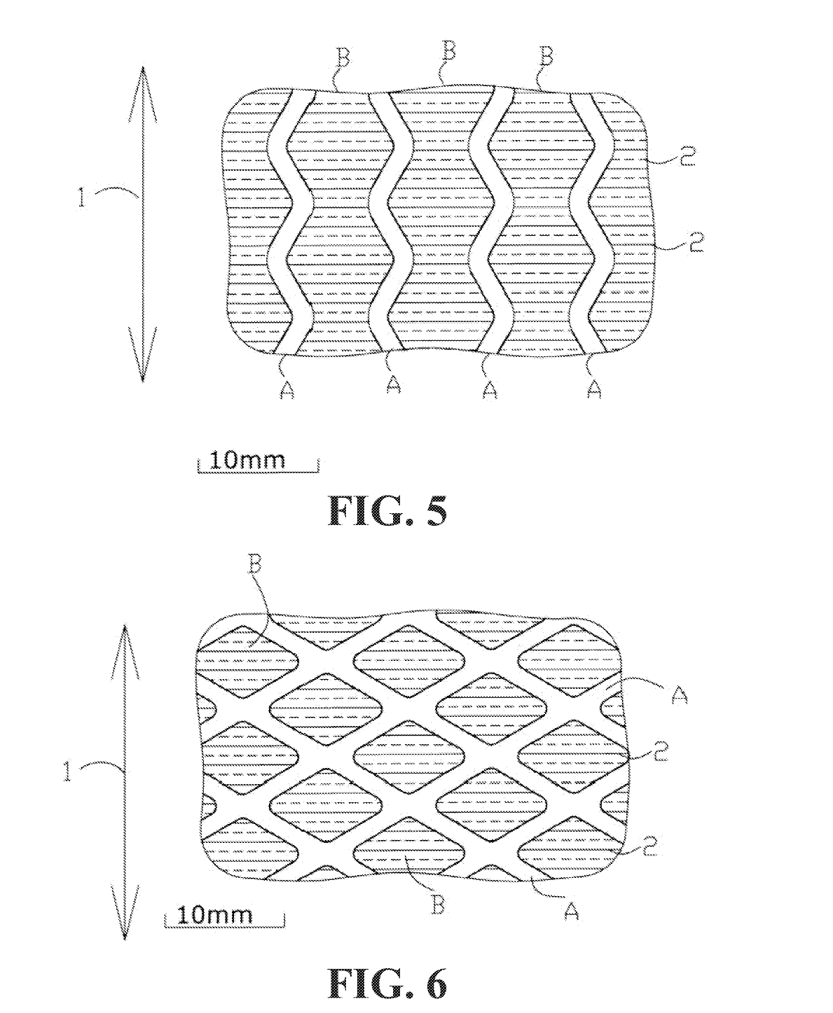

The methods of this invention may be used to form different patterns of regions (A) and (B) in the film as shown in FIGS. 3-6. In one embodiment, the pattern is such that each of the regions (A) and (B) are made as bands which rectilinearly extend either in the machine direction or in the transverse direction of the film. In another embodiment, the pattern is such that each of the regions (A) are made as bands which extend in a zig-zagging or waved manner. In still another embodiment, the pattern is such that each region (B) form dots or areas are surrounded on all side by the regions (A).

Since the invention mainly is applicable in the production of cheap products such as trash bags, the film should normally be constructed out of cheap polymers or polymer compositions. Very suitable polymers or polymer compositions include, without limitation, polypropylene (PP) or high density polyethylene (HDPE) or blends of the two, with coextruded surface layers comprising mainly linear low density polyethylene (LLDPE). The entire film may also comprise mainly LLDPE.

The film may be made as a laminate of two or more individual films or layers, whereby the lamination takes place after the extrusion or casting, but before the step of producing the pleating or waving.

In order to obtain a particular high tear propagation resistance, the individual films may be differently oriented, i.e., form a cross laminate.

As already mentioned, the invention is conceived especially with a view to the manufacture of bags, e.g., trash bags, but it can also find other important applications. One example is products for protection of sharp-edged items, e.g., furniture. A second example is products for cover of a human body or parts thereof, e.g. diaper or a raincoat. A third example is cling film for wrapping of pallets or other sharp-edged items.

A continuation (U.S. Pat. No. 5,330,133) of the Rasmussen patent mentioned in the introduction, claims that the there described film with a strainable embossed pattern may be suitable as a hood and/or strapping in certain parachutes due to the shock-absorbing effect. The present invention is similarly applicable.

Protection is also claimed for any film manufactured by the claimed methods. In this connection, the characteristic features of the product are hidden in the method claims of the present application.

Finally, protection is claimed for any apparatus suitable for carrying out the described method.

A thermoplastic film which exhibits rubberlike strain properties mainly in one direction (1) and comprises regions (A) and regions (B), wherein the film in regions (B) is discontinuous or disrupted and is pleated or waved at an average pitch of 5 mm or less extending perpendicular to the direction (1), and wherein the film in the regions (B) is shrinkable in direction (1), and wherein the film in regions (A) is relatively flattened and is less shrinkable than the film in regions (B) in said direction (1). The pleats or waves have an average pitch of less than 3 mm, preferably less than 2 mm, preferably less than 1 mm. The thermoplastic is selected from PP, PE, isobutylene and blends, preferably comprising LLDPE at least on the surface thereof. Each of the regions (A) and (B) are made as bands which rectilinearly extend either in the machine direction or in the transverse direction of the film. Each of the regions (A) is made as a band which extends in a zig-zagging or waved manner. Each region (B) forms dots or areas are surrounded on all side by the regions (A). The film is a laminate of two or more co-extensive individual films, preferably being differently oriented and arranged mutually crosslaminated. The film is in the form of a bag, preferably a trash bag; a product for protection of a sharp-edged item, preferably wherein the item is furniture; a product to cover a part of a human body, preferably wherein the product is a diaper or raincoat; or a hood and/or strapping of a parachute.

An apparatus suitable for carrying out the method of comprising: means to extrude or cast a continuous film of thermoplastic material; stretching means for stretching the film in one direction below the melting range of the thermoplastic material; pleating means for pleating the film to give an average pleating pitch of less than 5 mm, the pleats extending perpendicular to the said one direction; heating means for heating the pleated film in a pattern of areas to give regions (A) of the product film to a temperature allowing shrinkage of the film in said one direction; holding means for preventing shrinkage of the film in a pattern of areas to give regions (B) of the product while said heating is being carried out. The pleating means provides an average pleating pitch of less than 3 mm, preferably less than 2 mm, more preferably less than 1 mm. The heating means comprises a heated roller having protruding surface portions in a pattern corresponding to regions (A). The pleating means provides pleats extending in the machine direction and wherein the stretching means comprises mutually intermeshing grooved rollers having circular grooves or helical grooves of a gradient lower than 45°. The pleating means provides pleats extending in the transverse direction and wherein the stretching means comprises mutually intermeshing grooved rollers having axial grooves or helical grooves of a gradient higher than 45°. The pleating means comprise means for stuffing the film. The pleating means comprises rubber belts which engage the film. The apparatus further comprising stretching means for uniaxially stretching the extruded or cast film and means for laminating at least two uniaxially stretched films with the axes of the stretching being mutually crossed, upstream of the pleating means.

### DETAILED DESCRIPTION OF THE DRAWINGS OF THE INVENTION

### Methods of the Invention

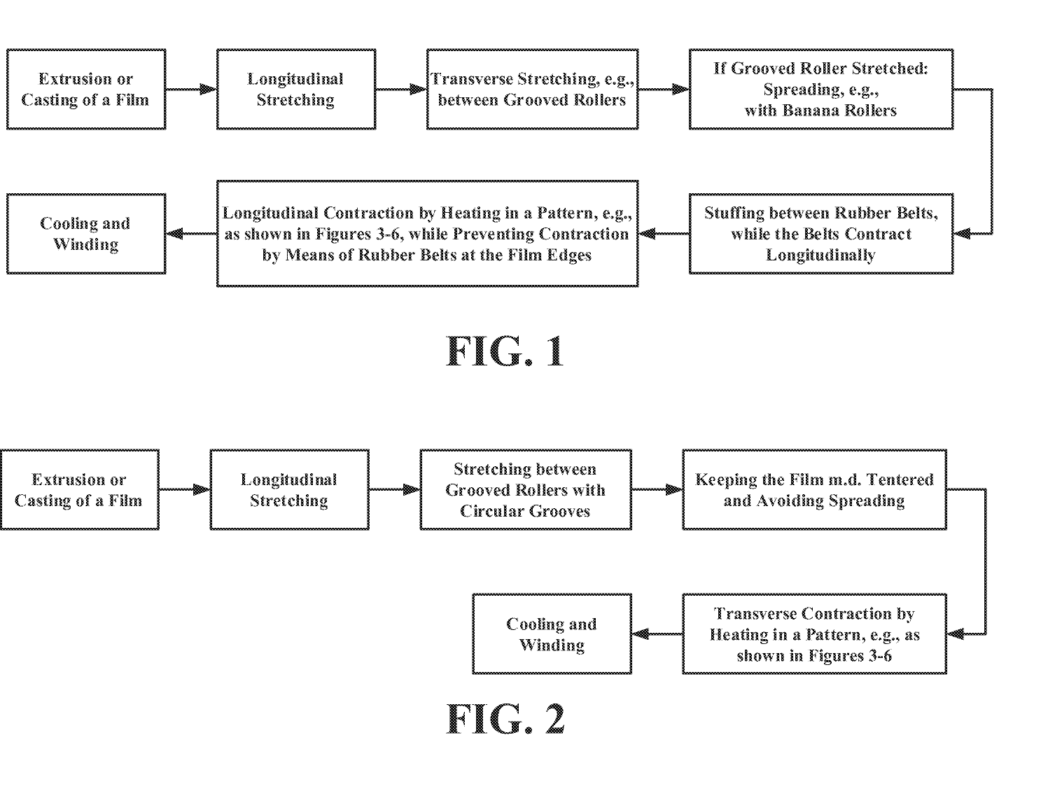

Referring now to FIG. 1, an embodiment of a method of this invention includes extruding or casting a film. The method also includes a longitudinal stretching of the film. Next, the longitudinally stretched film is transversely stretching of the film. In certain embodiments, the transverse stretching occurs between grooved rollers. The method may also include spreading the film over banana rollers, if the transverse stretching occurs over grooved rollers. The method also includes stuffing the film between rubber belts while the belts contract longitudinally. The method may also include longitudinal contraction by heating the film to form a pattern, while preventing contraction by means of rubber belts at the film edges. The method also includes cooling and winding the film.

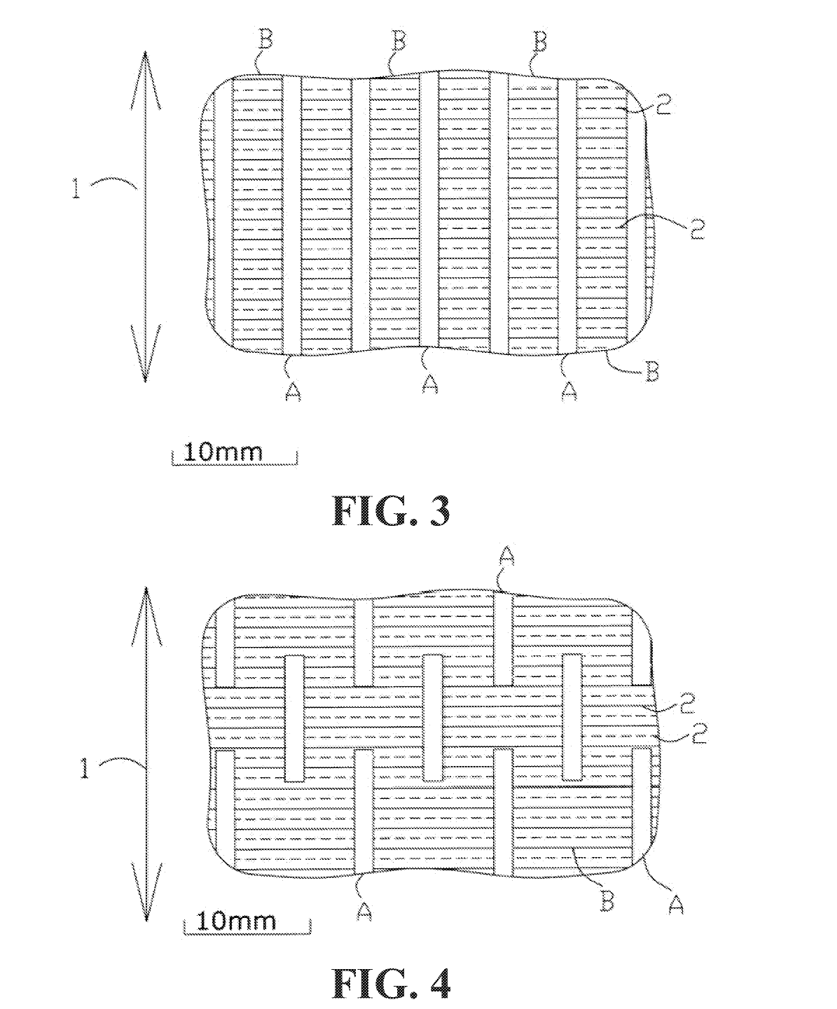

Referring now to FIG. 2, another embodiment of a method of this invention includes extruding or casting a film. The method also includes a longitudinal stretching of the film. Next, the longitudinally stretched film is stretched between grooved rollers. The method also includes keeping the film in the m.d. direction tentered and avoiding spreading. The method also includes transverse contraction by heating the film to form a pattern. The method also includes cooling and winding the film.

### Products to the Invention

Referring now to FIG. 3, 4, 5, or 6, the direction (1) is the most strainable direction, perpendicular to the direction of pleating. The regions (B) show the pleated or waved regions with a component of orientation in the direction (1), while the regions (A) are the regions which have been subjected to shrinkage. Lines (2) represents folds or top/bottom parts of pleats or waves in a direction making an angle with the direction (1), where the angle may be 30° to 90°. Thus, the lines (2) indicate the direction in which the pleats or waves extend. A length of each pleat or wave can conveniently be in a range between 2 mm and 20 mm, and a width of the regions (A) may range between 0.5 mm and 5 mm.

An embodiment of the invention is further illustrated on the following worked example.

### EXAMPLE

A tubular film is co-extruded, blown in a ratio about 1.2:1 and drawn down.

Composition:
Middle layer, 70% of total: HMWHDPE
2 surface layers, each 15% of total: LLDPE.

Gauge:
31.2 grams per sq. m. (gsm)

In lay-flat form, the tubular film is m.d. stretched at an ambient temperature between closely spaced rollers to obtain, after relaxation, an m.d. stretch ratio of 1.6 to 1, and gauge 20 gsm.

The tubular film is helically cut under 50″ to its longitudinal direction to 5 obtain a 20 gsm film, in which the main direction of the orientation forms 50° to the new m.d. This biased oriented film is sequentially stretched between mutually intermeshing grooved rollers with circular grooves (“ringrollers”). At the entrance to the grooved rollers the film is heated to 90° C. by passage over a heated roller.

The width of each groove on the ringrollers is 0.8 mm and the width of each crest is 0.4 mm. The depth of the intermeshing is 1.0 mm so that each stretched region is stretched up to a ratio of 5.0 to 1, but then relaxes and ends at a stretch ratio of about 4 to 1.

The sequentially stretched film is mechanically pulled off from the grooved rollers and spooled up under a tension sufficient to maintain the produced waving, i.e. avoiding that the film follow its natural tendency to spread out.

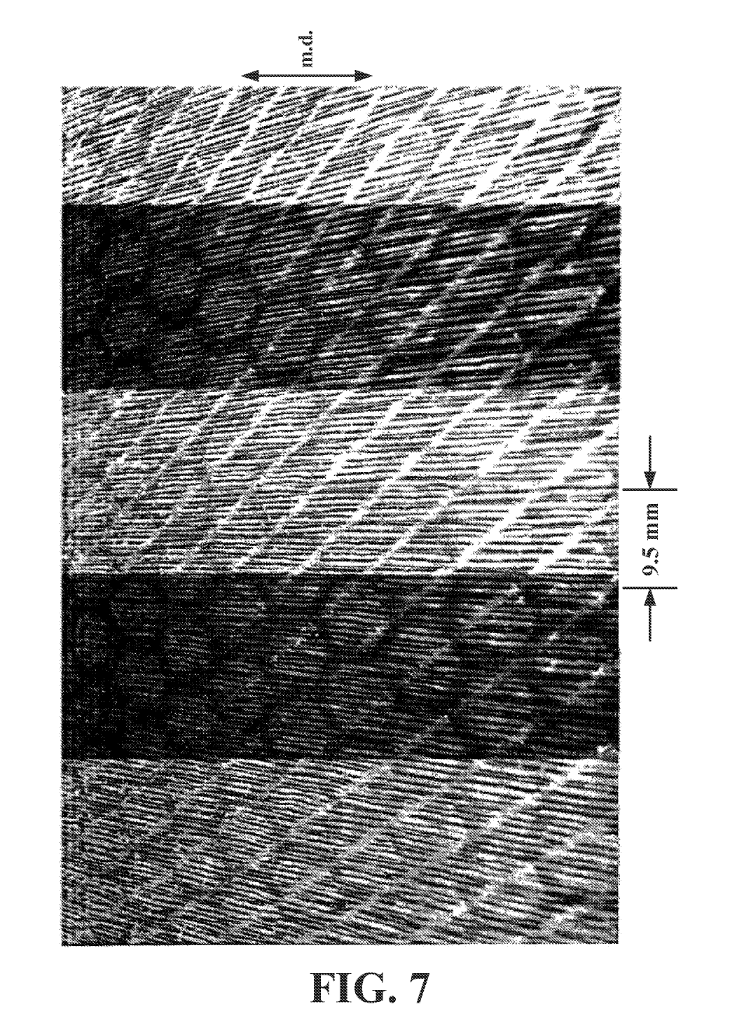

In a last step, the film, still under tension, is annealed in a hexagonal pattern, which appears from FIG. 7. This treatment is carried out on a roller with that surface pattern. The roller is heated to 100° C.

In the enlarged photo FIG. 7 the hexagonal pattern of 0.4 mm wide black lines shows the annealed pattern, where all waving has shrunk away, and the fine black lines show the waves, which are maintained all over where the film has not been heated.

### Closing Paragraph

Although the invention has been disclosed with reference to its preferred embodiments, from reading this description those of skill in the art may appreciate changes and modification that may be made which do not depart from the scope and spirit of the invention as described above and claimed hereafter.

1. A method of manufacturing a thermoplastic film which exhibits rubberlike strain properties mainly in one direction (1) comprising the steps of:
extruding or casting a film,
stretching the film below its melting range so that the entire film is oriented or an area of the entire film is oriented, where the stretching has a component in the direction (1) to make the film shrinkable in the direction (1),
simultaneously or subsequently, giving the film or the film area a pleated or waved shape having an average pitch of pleating or an average wavelength of the waves is 5 mm or less, whereby the extension of the pleats or waves is perpendicular to the direction (1),
heating the film or the film area in a pattern comprising regions (A) and allowing the film or the film area to shrink in the pattern along the direction (1), while a shrinkage perpendicular to the direction (1) is prevented by a holding means, if the film or the film area tends to shrink in the direction perpendicular to the direction (1) so that the regions (A) become flattened, while unheated film regions (B) of the film or the film area remain pleated or waved where the regions (B) are discontinuous or disrupted.

2. The method according to claim 1, wherein the heating is carried out by a heated roller having protruding surface portions corresponding to the regions (A).

3. The method according to claim 1, wherein the average pitch of pleating or the average wavelength of the waves is at the highest 3 mm

4. The method according to claim 1, wherein the average pitch of pleating or the average wavelength of the waves is at the highest 2 mm.

5. The method according to claim 1, wherein the average pitch of pleating or the average wavelength of the waves is at the highest 1 mm.

6. The method according to claim 1, wherein the pleats or waves extend in the machine direction of the film, and the pleating or wave formation and at least a final step of the stretching is carried out by means of mutually intermeshing grooved rollers having circular grooves or helical grooves of a gradient lower than 45°.

7. The method according to claim 1, wherein the pleats or waves extend transverse of the machine direction of the film, and the pleating or wave formation and at least a final step of the stretching are carried out by mutually intermeshing grooved rollers having axial grooves or helical grooves of a gradient higher than 45°.

8. The method according to any claim 1, wherein the pleats or waves are brought to extend transverse of the machine direction of the film, and the pleating or wave formation is carried out by stuffing the film or film area.

9. The method according to claim 8, wherein the stuffing is carried out between rubber belts which engage the film while it contracts from a longitudinally strained state to a less strained state.

10. The method according to claim 9, wherein the friction between the film and the rubber belts has been enhanced by making the extruded or cast film a cling film by a suitable addition of polyisobutylene.

11. The method according to claim 1, wherein each of the regions (A) and (B) are made as bands which rectilinearly extend either in the machine direction or in the transverse direction of the film.

12. The method according to claim 1, wherein each of the regions (A) are made as bands which extend in a zig-zagging or waved manner.

13. The method according to claim 1, wherein each region (B) form dots or areas are surrounded on all side by the regions (A).

14. The method according to claim 1, wherein the film mainly consists of PP or HDPE or blends of the two, which one or two coextruded surface layers mainly consisting of LLDPE.

15. The method according to claim 1, wherein the film is made as a laminate of two or more individual films, whereby the lamination takes place after the extrusion or casting but before the step of producing pleating or waving.

16. The method according to claim 15, wherein the individual films are differently oriented to produce a crosslaminate.

17. The method according to claim 1, further comprising forming the film into a bag.

18. (canceled)

19. (canceled)

20. (canceled)

21. (canceled)

22. (canceled)

23. (canceled)

24. (canceled)

25. (canceled)

25. (canceled)

26. (canceled)

27. (canceled)

28. (canceled)

29. (canceled)

30. (canceled)

31. (canceled)

32. (canceled)

33. (canceled)

34. (canceled)

35. (canceled)

36. (canceled)

37. The method according to claim 17, wherein the bag is a trash bag.

38. The method according to claim 1, further comprising:
forming the film into a product for protection of a sharp-edged item.

39. The method according to claim 38, wherein the item is furniture.

40. The method according to claim 1, further comprising:
forming the film into a product to cover a part of a human body.

41. The method according to claim 40, wherein the product is a diaper or raincoat.

42. The method according to claim 1, further comprising:
forming the film into a hood and/or strapping of a parachute.

43. A thermoplastic film manufactured by the method of claim 1.

44. An apparatus suitable for carrying out the method of claim 1.
